(19) United States
(12) Patent Application Publication
(10) Pub. No.: US 2006/0242837 A1
(43) Pub. Date: Nov. 2, 2006

(54) Method of manufacturing race for rolling bearing, and apparatus therefor

(76) Inventor: Koichi Nagano, Kanagawa-ken (JP)

Correspondence Address: MILES & STOCKBRIDGE PC, 1751 PINNACLE DRIVE, SUITE 500, MCLEAN, VA, 22102-3833, US

(21) Appl. No.: 11/477,658

(22) Filed: Jun. 30, 2006

Related U.S. Application Data
(62) Division of application No. 10/700,575, filed on Nov. 5, 2003.

(30) Foreign Application Priority Data
Nov. 7, 2002 (JP) JP2002-324436
Sep. 3, 2003 (JP) JP2003-311934

(51) Int. Cl. B21K 1/04; B23P 19/04; F16C 33/58

(52) U.S. Cl. 29/898.066; 29/724; 384/569

(57) ABSTRACT

A manufacturing apparatus for the race for a thin cross-section rolling bearing from a heat-treated pipe-shaped material W with a rib section 1 at one end thereof comprises a first spindle 11 having a clamping jig 14 to clamp the rib section 1, and a chuck 12 to securely hold the clamping jig 14; a machining unit 23 to process the pipe-shaped material W to form an annular member 10 via turning and/or grinding steps; and a second spindle 28 to retain the annular member, which has been cut off from the rest of the pipe-shaped material W, so that the end face of the annular member is subjected to turning and/or grinding steps, whereby the precision in roundness and uniformity in material thickness of the race is improved.

### TECHNICAL FIELD

The present invention relates to a method for accurately and efficiently manufacturing a heat-treated ring such as a race for the rolling bearing, a manufacturing apparatus which is used in the method, and a rolling bearing incorporating the race manufactured by the manufacturing method.

### BACKGROUND OF THE INVENTION

Conventionally, for example, in the manufacture of races for the thin cross-section rolling bearings, the finished part is made through many processes from the raw material, the processes involving; turning, heat treatment, surface grinding, external rough grinding, internal rough grinding, external finish grinding, and internal finish grinding (for example, see Japanese Patent Publication No. Tokukai Hei 06-246546, and Japanese Patent Publication No. tokukai Hei 06-246547.

However, with the races for the thin cross-section rolling bearings, in the conventional process, deformation due to the chuck in the grinding process and deformation during heat treatment and hardening, are greater than with the races for the general rolling bearings, which becomes a factor for increasing the margin in the grinding process. Moreover, regarding the heat treated thin cross-section race, when it is ground for the internal diameter after being ground for the external diameter, roundness of the external diameter becomes worse in precision due to residual stress in the internal structure. Therefore, roundness must be ensured through multiple process repetition. This causes problems which increase the manufacturing cost due to longer processing time, more manufacturing processes and the like.

### SUMMARY OF THE INVENTION

An object of the present invention, taking into consideration these problems of the conventional technology, is to ensure precision in roundness and material thickness uniformity in the race for the thin cross-section rolling bearing.

Another object of the present invention is to address; the point of forming a heat treated pipe-shaped material into individual shapes of races, the point of chucking the pipe-shaped material without affecting the diameter of the material, and the point of processing multiple numbers into individual principal race shapes in the chucked condition, in order to solve the problem of significantly suppressing deformation during grinding and heat treatment which occurs in the conventional manufacturing method.

### BRIEF DESCRIPTION OF THE DRAWING

FIG. 1 is a side elevational view with part omitted, showing an embodiment of a first spindle in a manufacturing apparatus of the present invention, wherein a pipe-shaped material is illustrated by cross section.

FIG. 2 is a side elevational view with part omitted, showing an embodiment of a second spindle in a manufacturing apparatus of the present invention,

FIG. 3 is a side elevational view with part omitted, showing an embodiment of a machining unit in a manufacturing apparatus of the present invention, where the turning bit and grinding stone are arranged for turning step in a direction with reference to the spindles.

FIG. 4 is a side elevational view with part omitted, showing an embodiment of a machining unit in a manufacturing apparatus of the present invention, where the turning bit and grinding stone are arranged for grinding step in another direction with reference to the spindles.

FIG. 5 is a cross-section showing a part of a pipe-shaped material with a rib section provided on the internal surface thereof for use in the present embodiment, where the areas 4 in the drawing denote manufacture-scheduled races.

FIG. 6 is a cross-section with part omitted, showing a condition where a clamping jig clamping a rib section of the pipe-shaped material is chucked by a chuck.

FIG. 7 is a cross-section with part omitted, showing a condition of an annular member formed at the free end of the pipe-shaped material after turning and grinding and before being cut-off.

FIG. 8 is an enlarged cross-section of part of FIG. 7.

FIG. 9 is a cross-section with part omitted, showing a condition immediately before the cutting-off step when a second spindle is abutted to an end face of the annular member for holding the annular member.

FIG. 10 is an enlarged cross-section of part of FIG. 9 where an annular member is still connected to the rest of the pipe-shaped material.

FIGS. 11(a) to 11(k) are a diagram showing a series of steps from turning and grinding of a pipe-shaped material to the cutting-off step, and then turning and grinding of an annular member which has been cut off from the rest of the pipe-shaped material.

FIG. 12 is a cross-section showing a clamp configuration in a form where a rib section is provided on the external surface of the pipe-shaped material.

FIG. 13 is a diagram showing a correlation between the material thickness ratio and the thickness deviation of a race for the thin cross-section rolling bearing.

### DETAILED DESCRIPTION OF THE PREFERRED EMBODIMENT

The preferred embodiments of the present invention for solving the abovementioned problems are as follows.

A manufacturing method for a race for the rolling bearing comprises the steps of: heat treating a pipe-shaped material formed into a cylindrical shape and provided with a rib section at one end thereof; chucking the one end of the heat treated pipe-shaped material via a clamping jig; forming the other end of the chucked pipe-shaped material into an annular member which is approximate to the desired race shape, via turning and/or grinding; holding the annular member on the side of the other end; cutting off the annular member from the rest of the pipe-shaped material to provide the annular member with an end face on the cut side, and subjecting the end face on the cut side of the annular member to turning and/or grinding.

A specific process for turning, grinding and cutting in the abovementioned process involves, for example: turning an end face on the afore-mentioned other end, that is on the opposite side to the chucked end, an external surface and an internal surface of the pipe-shaped material to form an annular member; then grinding the external surface, the end face and the internal surface of the annular member where a groove for raceway is formed in the internal or external surface; cutting off the annular member from the rest of the pipe-shaped material, then turning the end face on the cut side of the annular member which has been cut-off; and then grinding the end face on the cut side. Moreover, it is possible to omit all the grinding steps, or the grinding steps except for the grinding of the groove for raceway, from the series of steps. Further, it is also possible to omit only the grinding of the end face.

In the abovementioned manufacturing method, the pipe-shaped material used can have the rib section provided either on the internal diameter side or the external diameter side of the pipe-shaped material. The clamping jig used for the abovementioned manufacturing method, is configured to clamp the rib section in the axial direction of the cylindrical shape of the pipe-shaped material.

For the manufacturing apparatus used for manufacturing a race from a pipe-shaped material provided with a rib section at an end thereof and formed into a cylindrical shape, the following apparatus is given as an example. This apparatus comprises: a first spindle which holds one end of the heat-treated pipe-shaped material; a machining unit which forms the other end of the pipe-shaped material retained by the first spindle into an annular member of a desired shape via turning and/or grinding processes and cuts off the annular member from the rest of the pipe-shaped material to provide the annular member with an end face on the cut side; and a second spindle which retains the other end of the pipe-shaped material, and which also retains the annular member which has been cut off from the rest of the pipe-shaped material by the machining unit. The end face on the cut side of the annular member retained by the second spindle is subjected to turning and/or grinding using the machining unit. The first spindle is provided with a clamping jig which clamps the rib section of the material, and a chuck which securely supports the clamping jig.

It is also possible to individually arrange a machining unit which turns and grinds the pipe-shaped material, and a machining unit which turns and grinds the annular member being cut off.

The rib section can be provided on the internal or external diameter side of the pipe-shaped material. The clamping jig is configured to clamp the rib section in the axial direction of the cylindrical shape of the pipe-shaped material.

The second spindle is provided with a support structure for holding the annular member, and is configured to have a retaining face to mate with the annular member so as to attract and hold the annular member by magnetic force of the retaining face.

Moreover, the present invention provides a rolling bearing which is provided with a race with a material thickness ratio up to 4% manufactured via: heat treating a pipe-shaped material formed into a cylindrical shape and provided with a rib section at one end thereof; chucking one end of the heat treated pipe-shaped material via a clamping jig; forming the other end of the chucked pipe-shaped material into an annular member in a predetermined shape via turning and/or grinding; cutting off the annular member from the rest of the pipe-shaped material to form an end face on the cut side of the annular member; and retaining the annular member on the side of the other end and turning and/or grinding the end face formed on the cut side.

In an example, the race can be manufactured by: turning an end face on the afore-mentioned other end, that is the opposite side to the one end chucked, an external surface and an internal surface of the pipe-shaped material to form an annular member; then grinding the external surface, the end face, the internal surface of the annular member where a groove for a race is formed in the internal or external surface; cutting off the annular member from the rest of the pipe-shaped material to form an end face on the cut side of the annular member, then turning the end face on the cut side of the annular member; and then grinding the end face.

In another example, the race can be manufactured by: turning an end face on the afore-mentioned other end, that is the opposite side to the one end chucked, an external surface and an internal surface of the pipe-shaped material to form an annular member; then cutting off the annular member from the rest of the pipe-shaped material to form an end face on the cut side of the annular member, turning the end face on the cut side of the annular member; and then grinding the end face.

In another example, the race can be manufactured by: turning an end face on the afore-mentioned other end, that is the opposite side to the one end chucked, an external surface and an internal surface of the pipe-shaped material to form an annular member; then forming a groove for a race by grinding in the internal or external surface of the annular member; cutting off the annular member from the rest of the pipe-shaped material to form an end face on the cut side of the annular member, then turning the end face on the cut side of the annular member; and then grinding the end face.

In another example, the race can be manufactured by: turning the end face on the afore-mentioned other end, that is the opposite side to the one end chucked, an external surface and an internal surface of a pipe-shaped material to form an annular member; then grinding the external surface and the internal surface of the annular member where a groove for a race is formed on the internal or external surface of the annular member; cutting off the annular member from the rest of the pipe-shaped material to form an end face on the cut side of the annular member, and then turning the end face on the cut side of the annular member which has been cut off.

The race can be manufactured using a pipe-shaped material provided with a rib section on an internal diameter side thereof.

The race can be manufactured using a pipe-shaped material provided with a rib section on an external diameter side thereof.

The race can be manufactured via a clamping jig which clamps the rib section of the pipe-shaped material in the axial direction of the cylindrical shape thereof.

A chamfer section is formed through turning on the respective races.

The aforementioned race for rolling bearing, is directed for example, to a rolling bearing of the thin cross-section type.

According to the present invention, after heat treatment of the pipe-shaped material provided with a radially protruding rib section on one end side, it is possible to considerably suppress deformation during grinding and heat treatment, which occurs in conventional manufacturing methods by processing a single pipe-shaped material into a number of individual principal race shapes in a condition with the rib section chucked via a dedicated clamping jig.

According to the present invention, the pipe-shaped material is clamped by a standard hydraulic chuck. However, since the pipe-shaped material is previously fixed to a dedicated clamping jig and it is the clamping jig itself which is clamped by the chuck, the pipe-shaped material is finished to a high accuracy from the turning process to the final grinding process, without deformation of the material during chucking.

Further, in the bearing made by the present invention, after heat treatment, a chamfer section is necessarily subjected to a hard turning process, so that the externally produced scale due to the heat treatment process is removed. Furthermore, the chamfer section is processed under the same chucking reference as for the ground surface, so that the fact that there is no eccentricity can also be detected from the thickness deviation measurement. In the case of the outer ring, since there is no thickness deviation of the external diameter and chamfer section, then when the bearing is inserted into the housing, insertion is smoothly conducted. In other words, this is advantageous for easy execution.

Hereunder is a description of an embodiment of the present invention with reference to the drawings. The present invention should not be interpreted as being limited to just this illustrated embodiment of the present invention, and suitable design modifications are possible within the scope of the present invention.

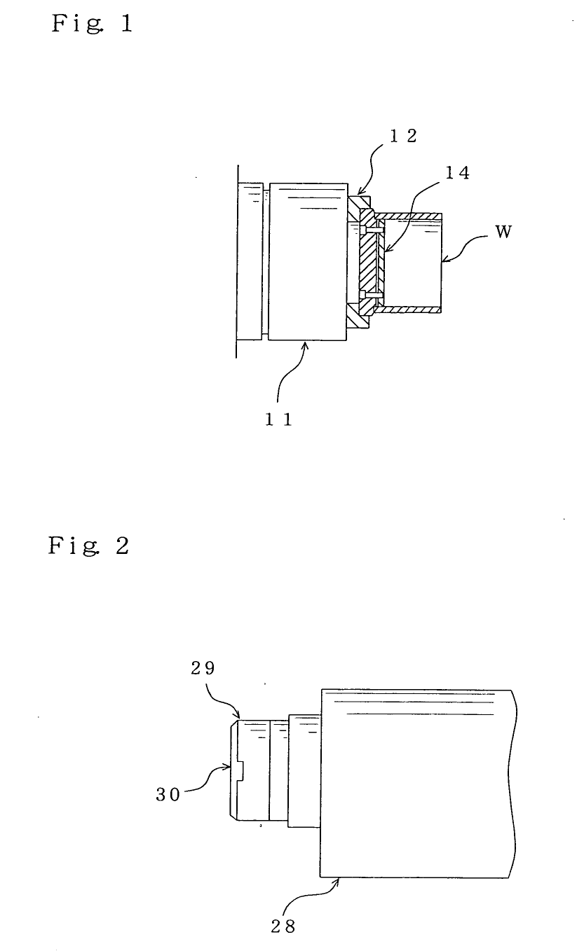

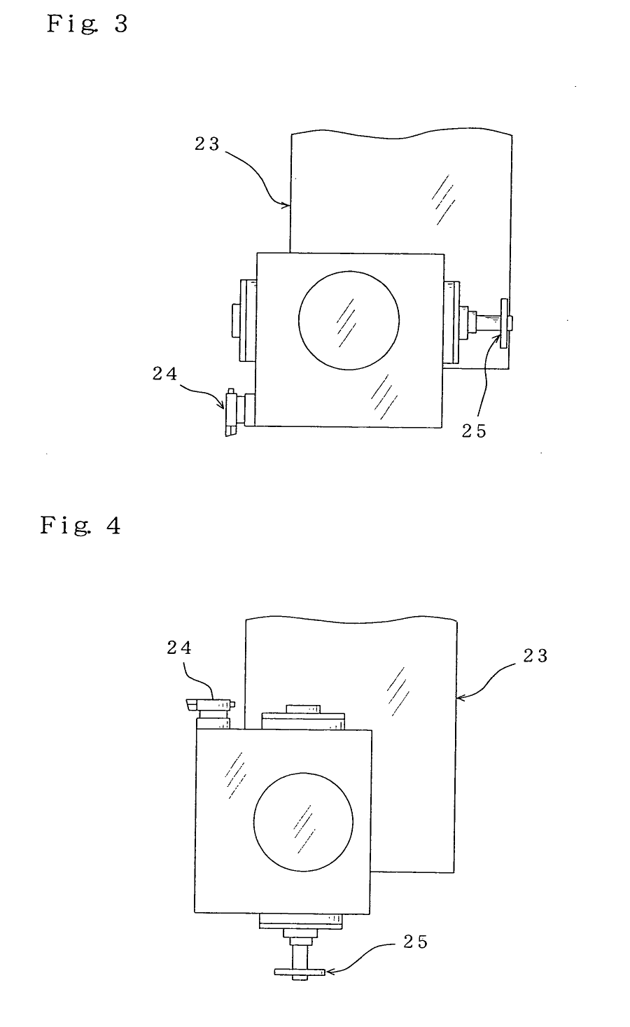

FIG. 1 to FIG. 4 show an embodiment of a manufacturing apparatus of the present invention. In the figure, the manufacturing apparatus comprises a first spindle 11 (FIG. 1), a second spindle 28 (FIG. 2), a machining unit 23 (FIGS. 3 and 4), to process a pipe-shaped material W.

The first spindle 11 comprises a general hydrealic chuck 12, a dedicated clamping jig 14 which is adapted to be grasped by the chuck 12, and to clamp the pipe-shaped material W. The second spindle 28 comprises a magnet cluck face plate 29 and a retaining section 30. The machining unit 23 comprises a turning bit 24 and a grinding groove 25 which can be changed in angular position as in FIGS. 3 and 4. In addition, a cutting-off device (not shown in FIGS. 1 to 4) is provided in the machining unit 23.

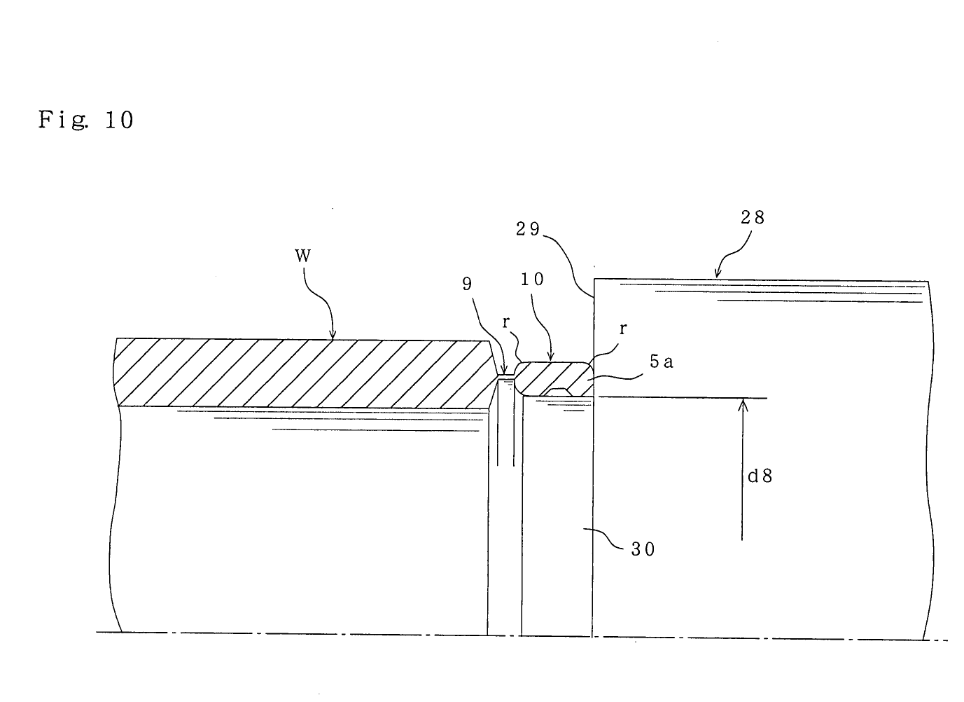

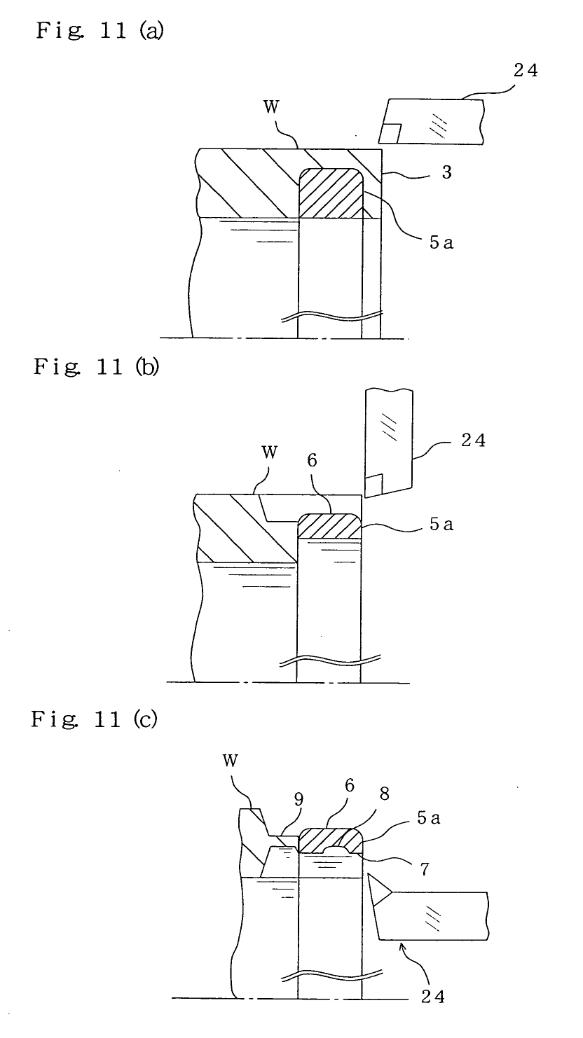

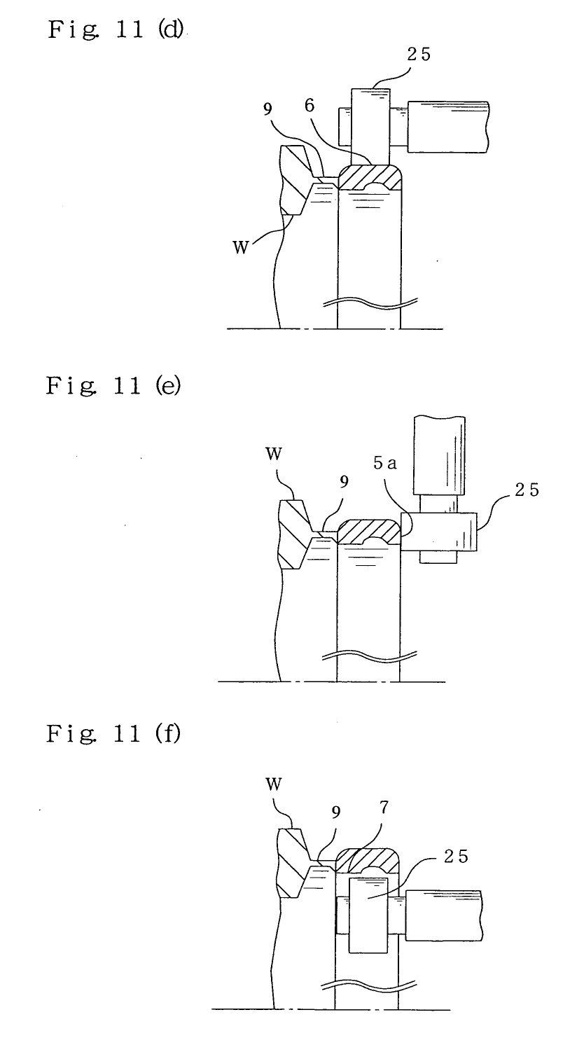

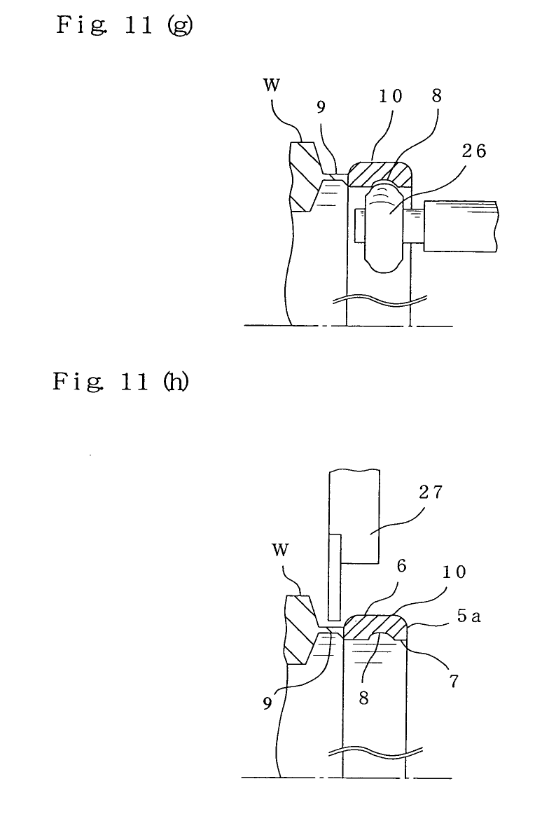

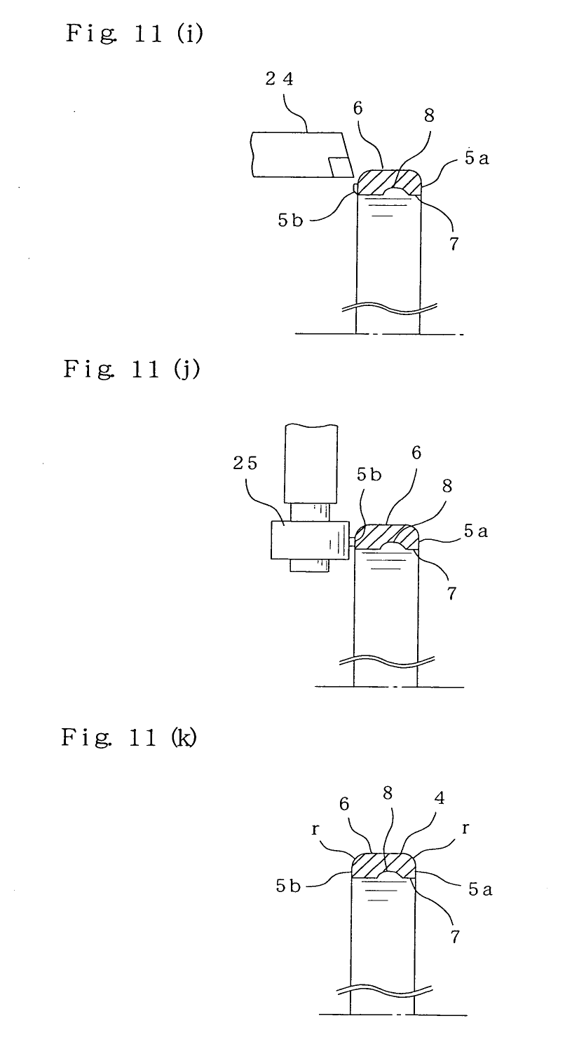

The present invention comprises at least the following manufacturing steps (a) to (e), to provide, for example, a race 4 for a rolling bearing of the thin cross-section type where the material thickness ratio in the race 4 manufactured by these steps is 4% or less, and where a chamfer section r is formed by turning on the race 4 (refer to FIG. 10 and FIG. 11). The term “material thickness ratio” here is calculated by the formula of (outer diameter−inner diameter)/2×outer diameter.

(a) heat-treating a pipe-shaped material W formed into a cylindrical shape and provided with a rib section 1 at one end thereof;

(b) chucking one end of the heat treated pipe-shaped material W via a clamping jig 14 provided on the first spindle 11;

(c) forming the other end of the chucked pipe-shaped material W via turning and/or grinding into a predetermined annular shape, which becomes an approximate race shape, to provide an annular member 10 having an end face 5a;

(d) cutting off the annular member 10 from the rest of the pipe-shaped material W to provide the annular member with an end face 5b on the cut side, and holding the annular member 10 with the second spindle 28, and

(e) turning and/or grinding the end face 5b on the cut side of the annular member 10.

The present embodiment is explained using the race 4 for the ball bearing as an example, however, it is not limited to this, and races of other bearing forms such as a roller bearings or the like are possible within the scope of the present invention. Furthermore, the present embodiment is explained using an outer race, however it may of course be applied to an inner race.

Hereunder is a description of details of an embodiment of respective steps, and an apparatus used in the respective processes.

“Heat Treatment Step”

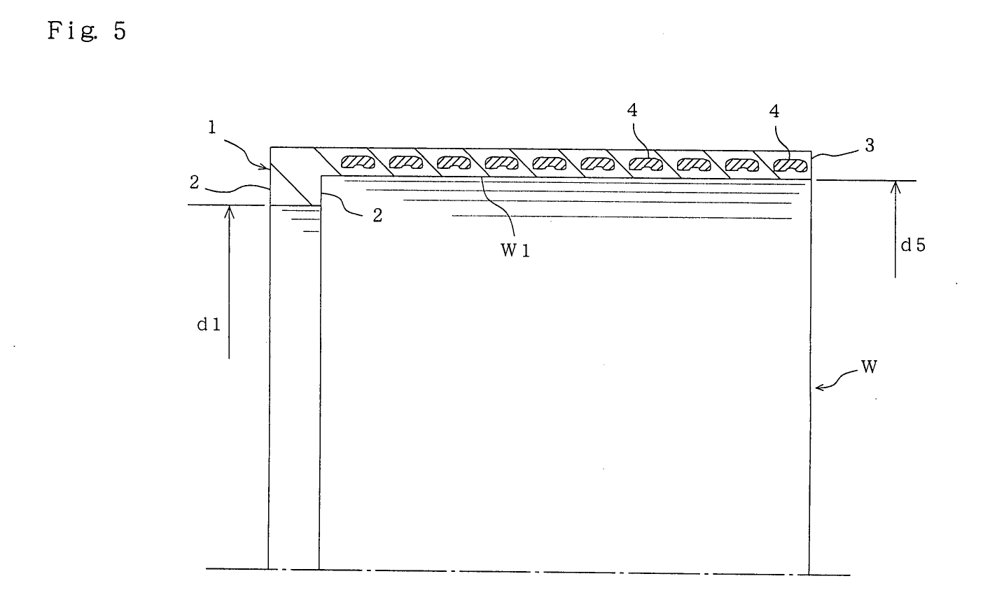

In the present invention, as shown in FIG. 5, a pipe-shaped material W is provided with the radially protruding rib section 1 on the inside surface of one end thereof, and formed (through a preliminary turning process) into a cylindrical shape of a desired diameter and desired material thickness. FIG. 5 is a cross-section showing a part of the pipe-shaped material W provided with the rib section 1 on the inside surface thereof for use in the present embodiment, where the areas 4 in the drawing denote races to be manufactured.

This configuration of the pipe-shaped material W is simply an example and is not limiting the present invention.

That is, in the present invention, the rib section 1 is formed into an annular shape (continuous circular shape) having a desired height in the radial direction and a desired width in the axial direction of the pipe-shaped material W. However, for example, the rib section 1 may be intermittently formed around the circumferential direction (a rib section formed as protruding segments spaced at desired intervals around the circumferential direction) of the pipe-shaped material W. Such a pipe-shaped material W is first heat-treated prior to the machining process such as turning by the machining unit 23.

For the heat treatment method, a well known heat treatment method is suitably selected and used. The pipe-shaped material W is made of bearing steel or the like in the embodiment, but not limited to this substance. For example, in the case where the configuration of the second spindle 28 detailed later is adopted, this pipe-shaped material W is desirably able to be magnetically chucked by the magnetic force on the retaining face of the second spindle 28.

“Chucking Step for Pipe-Shaped Material”

After the abovementioned heat-treated pipe-shaped material W is clamped via the dedicated clamping jig 14, the clamping jig 14 is grasped by the tip chuck 12 of the first spindle 11 as shown in FIG. 1. In the present embodiment, the rib section 1 protruding in the radial direction of the pipe internal surface W1 of the pipe-shaped material W, is clamped in the axial direction of the pipe-shaped material W by the clamping jig 14.

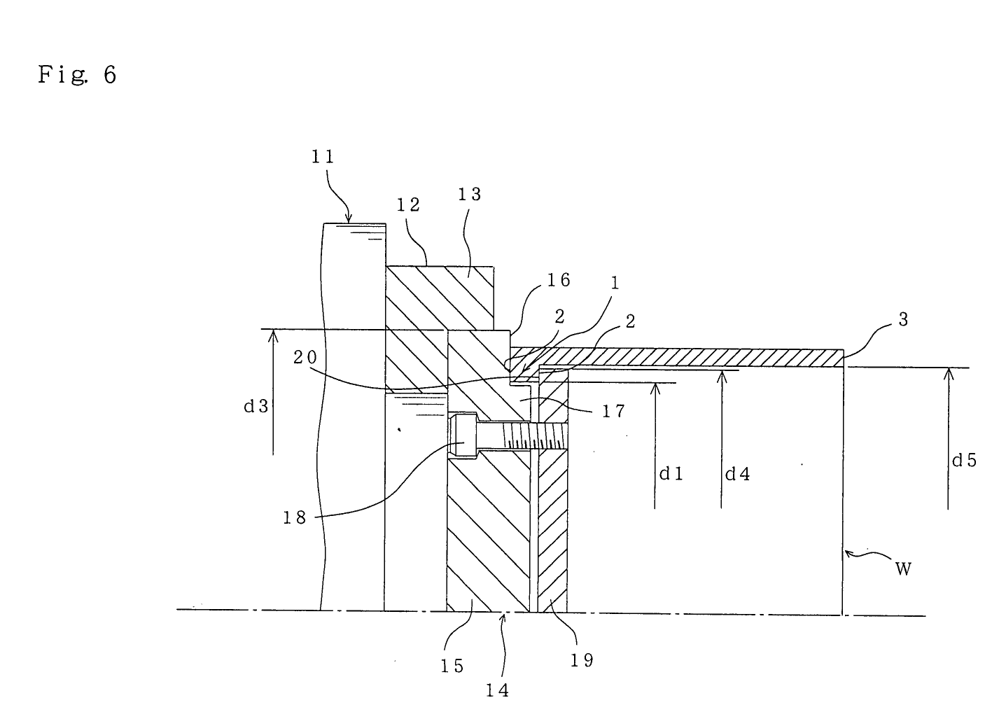

As a result, the pipe-shaped material W is indirectly fixed to the first spindle 11 via the clamping jig 14, and coaxially retained on the tip of first spindle 11 (refer to FIG. 6).

Therefore, according to the present invention, since the clamping jig 14 is chucked by the first spindle 11, the thrust due to the chuck 12 is exerted on the clamping jig 14, but is not exerted on the rib section 1. Further, the rib section 1 is clamped by means of the clamping jig 14 in the normal direction to the opposite planes 2 (FIGS. 5 and 6) of the rib section 1, that is, in the axial direction of the pipe-shaped material W. Therefore, there is no deformation in the radial direction of the pipe-shaped material W, so that it is possible to ensure precision in roundness and material thickness uniformity after machining (refer to comparison data in Table 1).

Table 1 shows precision in roundness and thickness deviation, comparing the present invention with the conventional technology, wherein the “work” denotes the pipe-shaped material. In Table 1, the chuck pressure of work No.1 is 7 kg/cm², and the chuck pressures of works No. 2 and No. 3 are 4 kg/cm².

TABLE 1

| | | | Comparative | | | | | |
|---|---|---|---|---|---|---|---|---|
| | | | Example 1 | | | Example 1 | | |
| | | | Test Apparatus | | | | | |
| | | | NC Lathe | | | | | |
| | | | Method of | | | | | |
| | | | chucking the work | | | | | |
| | | | Clamped at | | | Clamped | | |
| | | | three-points | | | on the | | |
| | | | in the | | | end | | |
| | | | circum- | | | faces of | | |
| | | | ferential | | | the | | |
| | | | direction | | | rib section | | |
| | | | Work No. | | | | | |
| | | | 1 | 2 | 3 | 1 | 2 | 3 |
| Before- | precision on | *ex. dia. | 12 | 12 | 4 | 1 | 2 | 2 |
| Cutting- | machine (runout) | *in. dia. | 20 | 8 | 4 | 1 | 1 | 1 |
| off | | end face | 5 | 17 | 2 | 1 | 1 | 2 |
| After- | roundness | *ex. dia. | 62 | 65 | 93 | 30 | 41 | 51 |
| Cutting- | | *in. dia. | 58 | 66 | 91 | 33 | 38 | 48 |
| off | | | | | | | | |

| | | | | | | |
|---|---|---|---|---|---|---|
| thickness deviation | 13 | 8 | 9 | 2 | 4 | 7 |

(*ex dia. = external diameter, in. dia. = internal diameter)

As previously mentioned, the first spindle 11 is provided with the general hydraulic chuck 12 at the tip thereof. The dedicated clamping jig 14 is chucked by the chuck 12, and therefore the pipe-shaped material W that is clamped at one end thereof by the clamping jig 14 is indirectly retained by the hydraulic chuck 12.

The clamping jig 14 adopts a configuration whereby the rib section 1 projecting in the radial direction of the pipe-shaped material W at one end thereof can be clamped in the axial direction (refer to FIG. 6). For example, in the present embodiment, the clamping jig 14 comprises a receiving member 15 and a clamping member 19, such that the receiving member 15 has an external diameter d3 so as to be retained by the chuck fingers 13 of the first spindle 11, and a retaining section 17 of smaller diameter than an internal diameter d1 of the rib section 1 protrudingly provided on the tip thereof; and that the clamping member 19 is fastened to the receiving member 15 via bolts 18, and has an external diameter d4 smaller than the internal diameter d5 of the pipe-shaped material W. By inserting the retaining section 17 of the receiving member 15 into the inner periphery (internal diameter d1) of the rib section 1, and clamping the clamping member 19 inside of the pipe-shaped material W by the bolts 18, the rib section 1 is clamped in the axial direction between an end face 20 of the clamping member 19 and an end face (stepped section) 16 of the receiving member 15.

Regarding the abovementioned clamping jig 14, in the present embodiment, the receiving member 15 is formed in an overall annular shape, and the end face 16 on the outer periphery is formed in an annular shape having a desired height in the radial direction and a desired width in the axial direction of the pipe-shaped material W. The clamping member 19 is formed an overall annular shape of a desired diameter and desired width.

The clamping jig 14 of the present embodiment is simply an example and the present invention is not limited to this embodiment. That is, for example, the receiving member 15 and the clamping member 19 may be intermittently formed around the circumferential direction, and may be any configuration provided that the receiving member 15 and the clamping member 19 are able to clamp the rib section 1. Therefore, the clamping jig 14 and the rib section 1 may be suitably modified in design within the scope of the present invention.

Moreover, in the present embodiment, the construction is such that the rib section 1 of the pipe-shaped material W is clamped by width adjustment of the interval between the receiving member 15 and the clamping member 19 by bolt tightening via the bolts 18. However, it is of course possible to use another member instead of the bolts 18. Further, the configuration may be such that the receiving member 15 and the clamping member 19 themselves have respective clamping configurations on their respective facing surfaces whereby the rib section 1 can be clamped by width adjustment of the interval between them. For example, a male screw section and a female screw section may be directly formed as a unit respectively on the facing surface of the receiving member 15 and on the facing surface of the clamping member 19, giving a configuration for clamping by screwing these together.

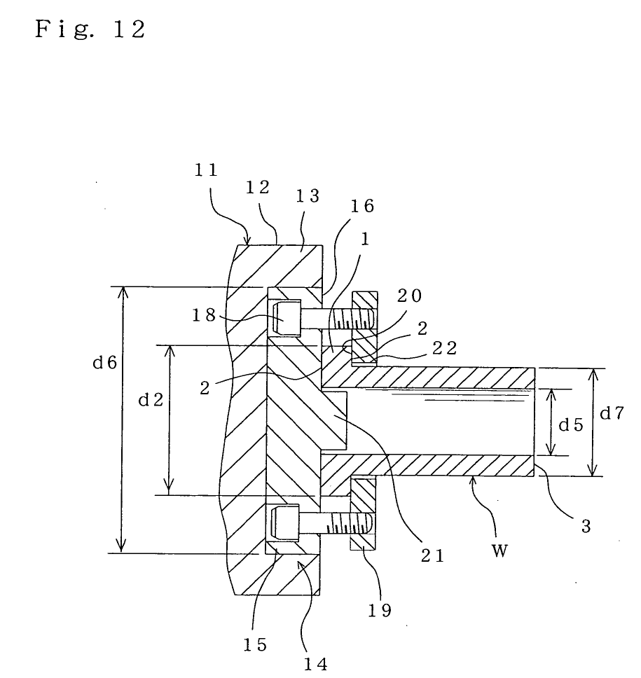

Furthermore, in the pipe-shaped material W used in the present invention, instead of the configuration where the rib section 1 protrudes inward in the radial direction from the internal surface of the pipe-shaped material W as with the abovementioned embodiment, the rib section 1 may protrude outward in the radial direction from the external surface. In this case, the clamping jig 14 adopts for example, the configuration exemplified in FIG. 12.

That is to say, this clamping jig 14 comprises a receiving member 15 and a clamping member 19. The receiving member 15 has an external diameter d6 such that it can be retained by chuck fingers 13 of the first spindle 11, and a retaining section 21 protrudingly provided on its tip and having a smaller diameter than an internal diameter d5 of the pipe-shaped material W. The clamping member 19 is fastened to the receiving member 15 via bolts 18, and has an insertion aperture 22 with a diameter bigger than an external diameter d7 of the pipe-shaped material W and smaller than an external diameter d2 of the rib section 1. By inserting the retaining section 21 of the receiving member 15 into the inner periphery of the rib section 1, and clamping the clamping member 19 arranged outside of the pipe-shaped material W by the bolts 18, the rib section 1 is clamped in the axial direction between the end face 20 of the clamping member 19 and the end face (stepped section) 16 of the receiving member 15.

“Forming and Cutting Steps of the Annular Member”

As mentioned above, with one end of the pipe-shaped material W retained by the first spindle 11, the other end or free end 3, that is, opposite to the one end of the pipe-shaped material W which is chucked, is continuously processed from hard turning to grinding by a machining unit 23 (FIGS. 11(a) to 11(k)) to form an annular member 10, which is illustrated by fine hatching area in the drawings.

That is to say, firstly, by applying a turning bit 24 of the machining unit 23 to the other end or free end of the pipe-shaped material W, the end face 5a of the annular member 10 is formed through turning (FIG. 11 (a)). Next, by applying the turning bit 24 to the external surface of the pipe-shaped material W, the external surface 6 of the annular member 10 is formed (FIG. 11 (b)). Then, by applying the turning bit 24 to the internal surface of the pipe-shaped material W, the internal surface 7 of the annular member 10 is formed through turning (FIG. 11 (c)). Moreover, the internal surface 7 is formed with a groove by turning to provide a raceway 8 (FIG. 11 (c)). Then, after that, by applying a grinding stone 25 to the external surface 6, the external surface 6 is ground (FIG. 11 (d)). Then, by applying the grinding stone 25 to the end face 5a, the end face 5a is ground (FIG. 11 (e)). Next, by applying the grinding stone 25 to the internal surface 7, the internal surface 7 is ground (FIG. 11 (f)) and then, by applying a groove-grinding stone 26 instead of the grinding stone 25 to the internal surface 7, the raceway 8 is formed by grinding (FIG. 11 (g)). Through such turning and grinding steps applied to the respective parts, the annular member 10 of a desired material thickness and desired width for a race is formed.

Further, the turning sequence and grinding sequence for the respective parts are not limited to this, and design modifications are possible within the scope of the present invention.

For the machining unit 23, for example, a CNC lathe with a grinding stone spindle provided with a general turning bit 24 for the turning section and with a general grinding stone 25 for the grinding section, is adopted (refer to FIG. 3 and FIG. 4). The turning bit 24 and the grinding stone 25 are not specifically limited. In the present embodiment, for the machining means which turns and grinds the pipe-shaped material W and for the machining means which turns and grinds the annular member 10 after cutting, the same machining unit 23 is used. Further, for a cutting-off device 27, a well known configuration is adopted with no specific limitation. The cutting-off device 27 can be included in the machining unit 23. The machining unit which turns and grinds the pipe-shaped material W may be different from the machining unit which turns and grinds the annular member 10 after cutting.

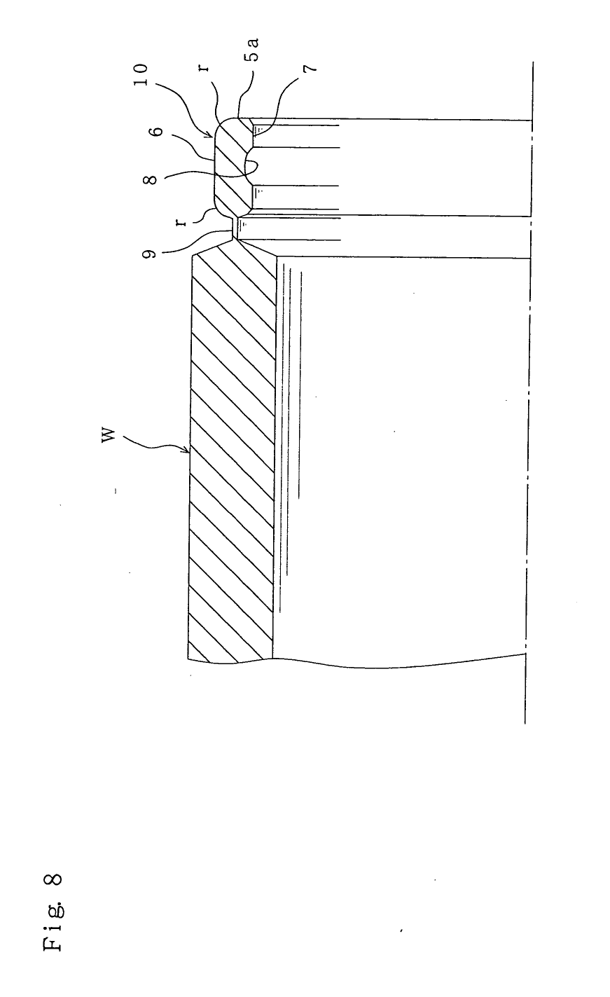

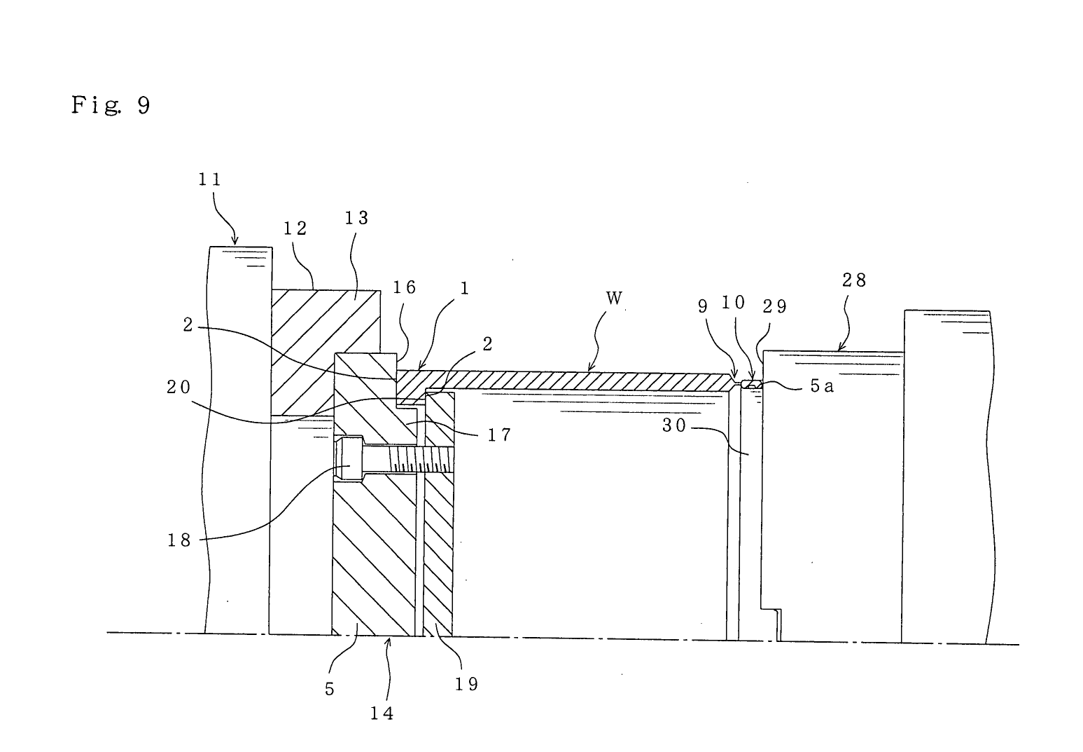

As described above, the connecting part 9 of the annular member 10, which is formed after turning and grinding of the respective parts, is cut off (FIG. 11 (h)) by means of the cutting-off device 27, which is provided on the rear side of the machining unit 23 in the embodiment. Here, this cutting-off step for the annular member 10, is conducted with the annular member 10 retained by the second spindle 28 (see FIG. 9 and FIG. 10). Specifically, the second spindle 28 is operated to support the annular member 10 just before the cutting-off step

In the present embodiment, a retaining section 30 of the second spindle 28 (refer to FIG. 9 and FIG. 10) is inserted into the internal periphery of the annular member 10. Since the second spindle 28 has a magnet chuck faceplate 29, then in a condition where the end face 5 of the annular member 10 on the opposite side to the chuck 12 is attracted and retained by the second spindle 28, the connecting part 9 is cut off by the cutting-off device 27 (FIG. 11(h)), and the annular member 10 of an approximate outer race shape is separated from the rest of the pipe-shaped material W. The annular member 10 is provided with an end face on the cut side (left side in FIG. 11(h)).

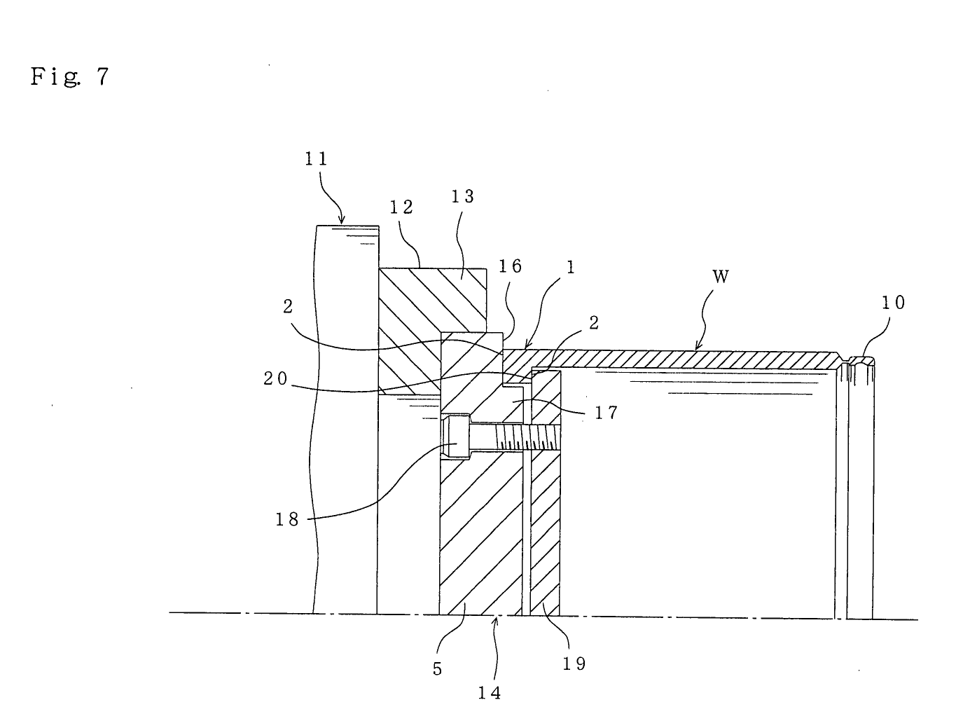

FIG. 7 shows the shape of the annular member 10 processed until turning, where the shape of the connecting part is effective in order to maintain the roundness of the annular member 10 during cutting-off (FIG. 8 is a enlarged drawing of FIG. 7). At this time, by keeping the material thickness and the grinding margin of connecting section to be cut to a necessity minimum, it is possible to suppress the residual stress, so that the final product size, roundness and material thickness uniformity can be ensured by continuous grinding processes for the external and internal surfaces.

“Processing Step of the End Face on the Cut Side”

The annular member 10 of race shape, which is cut-off and separated while being retained by the magnet chuck face plate 29 of the second spindle 28, is subjected at its end face on the cut side to the finishing grinding, retained by the second spindle 28, to give the finished part or race 4 (from FIG. 11 (i) to FIG. 11 (k)).

That is to say, in the present embodiment, firstly, with the machining unit 23 which is used for forming the annular member 10, the end face 5b on the cut-off side is turned by the turning bit 24 (FIG. 11 (i)). Next, the turned end face 5b is ground with the grinding stone 25 (FIG. 11 (j)) to give the finished part or race 4 (FIG. 11 (k)).

Since the second spindle 28 has the magnet chuck face plate 29, and when the retaining section 30 having an external diameter d8 fitted with the internal diameter of the annular member 10 is inserted into the internal periphery of the annular member 10, the end face 5a is attracted and held by the magnet chuck face plate 29 (refer to FIG. 9 and FIG. 10). That is to say, the second spindle 28 provides a retaining means for the race (annular member) during the cutting-off step, and a chucking means for ensuring accuracy of the grinding process for the end face 5b on the cutting-off side, wherein resistance during the cutting-off step is received by the magnet chuck face plate 29 and the retaining section 30, enabling processing of the end face 5b with the annular member 10 held by the second spindle 28. Moreover, by previously eliminating any run-out of the magnet chuck face plate 29, uniformity in width of the end face on the cutting-off side in the product or race after grinding can be ensured.

In the present embodiment, the magnet chuck configuration is used. However, the chuck is not limited to this configurations, there being no limitation provided that the configuration is such that the annular member 10 can be retained between the first spindle 11 and the second spindle 28, and that the turning and grinding steps by the machining unit 23 after the cutting-off step are possible while retaining the annular member 10 by the second spindle 28.

In another embodiment in the present invention, for example, it is also possible to omit, from the abovementioned series of processes, all of the grinding processes, or all of the grinding processes except for the grinding for the raceway forming. Moreover, it is also possible to omit only the grinding of the end face.

That is to say, for example, the abovementioned race 4 may be manufactured by turning the end face on the opposite side to the chuck 12, the external surface and the internal surface of the pipe-shaped material W (FIG. 11 (a), FIG. 11 (b) and FIG. 11 (c)) to form the annular member, then, turning the end face 5b on the cut-off side of the annular member 10 (FIG. 11 (i)) which has been cut off (FIG. 11 (h)), and next, grinding the end face 5b (FIG. 11 (i)).

Further, it may be manufactured by turning the end face on the opposite side to the chuck 12, the external surface and the internal surface of the pipe-shaped material W (FIG. 11 (a), FIG. 11 (b) and FIG. 11 (c)) to form the annular member 10, next, grinding the internal surface 7 of the annular member 10 for forming the raceway 8 (FIG. 11 (g)), after that, turning the end face 5b on the cut-off side of the annular member 10 (FIG. 11 (i)) which has been cut off (FIG. 11 (h)), and next, grinding the end face 5b (FIG. 11 (j)).

Furthermore, it may be manufactured by turning the end face on the opposite side to the chuck 12, the external surface and the internal surface of the pipe-shaped material W (FIG. 11 (a), FIG. 11 (b) and FIG. 11 (C)) to form the annular member 10, next, grinding the external surface 6, and the internal surface 7 of the annular member 10 with the raceway 8 formed on the internal surface 7 (FIG. 11 (d), FIG. 11 (f) and FIF. 11 (g)), and after that, turning the end face 5b on the cut-off side of the annular member 10 (FIG. 11 (i)) which has been cut off (FIG. 11 (h)).

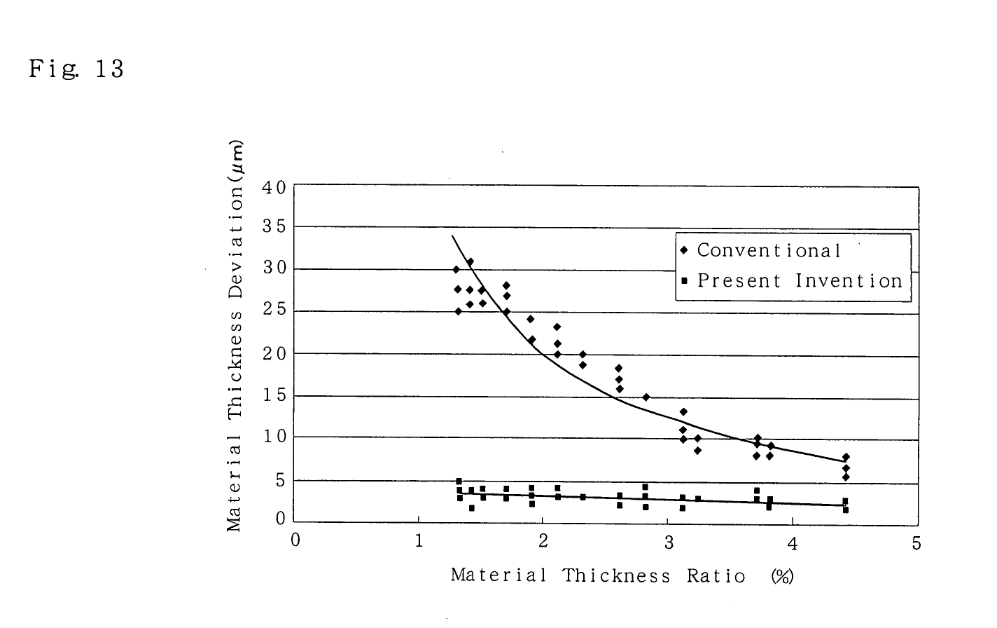

Here FIG. 13 shows a correlation of material thickness ratio and thickness deviation for the race for a thin cross-section rolling bearing manufactured by the present invention and a conventional race for rolling bearing. The term “material thickness ratio” is calculated by the formula of: (outer diameter-inner diameter)/2×outer diameter. The term “thickness deviation” means the ratio of the material thickness of the race to the inner diameter of the race. For the present invention, the race is manufactured by the manufacturing method of the abovementioned embodiment, while for the conventional, the race is manufactured by a grinding method using a shoe type centerless grinder (external surface and internal surface). According to the graph in FIG. 13, as the material thickness ratio becomes close to more than 5%, the thickness deviation (μm) of the present invention becomes close to that of the conventional to some degree. However, when the material thickness ratio is less than 4%, the difference is remarkably apparent. That is to say, for the conventional, as the material thickness ratio becomes less than 4%, the thickness deviates rapidly. However for the present invention, even if the material thickness ratio becomes close to 1%, there is not much change, and the degree of thickness deviation is minimal.

According to the present embodiment, when the annular member 10 (individual shape) is formed before the grinding process, by providing a auxiliary groove or connecting portion for cutting-off the annular member 10 from the rest of the pipe-shaped material W and by minimizing the cutting-off margin, it becomes possible to keep the deformation in the annular member after cutting-off to a minimum.

Moreover, the finishing process for the end face 5b on the cutting-off side of the annular member 10 is conducted while retained by the chuck configuration of the second spindle 28, so that the complete part of race can be finished with a single manufacturing unit 23, giving a significant reduction in manufacturing time.

As to clamping the pipe-shaped material W through the general hydraulic chuck 12 in the embodiment of the present invention, the pipe-shaped material W itself is fixed by the dedicated clamping jig 14 which is in turn clamped by the general hydraulic chuck 12, and therefore the pipe-shaped material W gets rid of any deformation during being chucked, so that high precision finishing is possible from the turning step to the finishing grinding step.

In the rolling bearing produced by way of the present invention, the chamfer section r is subjected to hard-turning after heat-treatment, whereby any scale produced through the heat-treatment step is removed. The chamfer section r is processed with the same chuck reference as the ground surfaces, there is no eccentricity, which is found through measurement of thickness deviation. By applying the present invention to the outer race of a rolling bearing, it becomes easy to insert the rolling bearing into the housing because the outer race has no deviation in outer diameter and material thickness.

1-9. (canceled)

10. A manufacturing apparatus for a race for a rolling bearing comprising:
a first spindle which retains one end of a pipe-shaped material formed into a cylindrical shape and provided with a rib section at the one end thereof;
a machining unit which processes the other end of the pipe-shaped material into an annular member of a desired shape via turning and/or grinding processes; and
a cutting-off device which cuts off the annular member from the rest of the pipe-shaped material;
a second spindle which retains the annular member before and after being cut off by the cutting-off device,
said machining unit being used in order that the end on the cut side of the annular member is subjected to turning and/or grinding processing while the annular member is retained by said second spindle, and
the one end of the pipe-shaped material being formed with a rib section, and said first spindle being provided with a clamping jig which clamps the rib section of the pipe-shaped material, and a chuck which securely supports the clamping jig.

11. A manufacturing apparatus for a race for a rolling bearing according to claim 10, wherein the machining unit comprises a first machining means which turns and grinds the pipe-shaped material and the annular member formed in the pipe-shaped material and a second machining unit which turns and grinds the annular member after being cut off.

12. A manufacturing apparatus for a race for a rolling bearing according to claim 10, wherein the clamping jig is configured to clamp the rib section in the axial direction of the cylindrical shape.

13. A manufacturing apparatus for a race for a rolling bearing according to claim 12, wherein the clamping jig is provided with a configuration for clamping a rib section provided on the internal diameter side of the pipe-shaped material.

14. A manufacturing apparatus for a face for rolling bearing according to claim 12, wherein the clamping jig is provided with a configuration for clamping a rib section provided on the external diameter side of the pipe-shaped material.

15. A manufacturing apparatus for a race for rolling bearing according to claim 10, wherein said second spindle is provided with a retaining face to mate with the annular member, and configured so as to attract and hold the annular member by magnetic force of said retaining face.

16. A manufacturing apparatus for a race for rolling bearing according to claim 10, for manufacturing a race of the thin cross-section rolling bearing.

17-19. (canceled)
